(19) United States
(12) Patent Application Publication
(10) Pub. No.: US 2021/0318038 A1
(43) Pub. Date: Oct. 14, 2021

(54) HEATING SYSTEM

(71) Applicant: IHANDAL ENERGY SOLUTIONS SDN BHD, Shah Alam, Selangor (MY)

(72) Inventor: Aaron C. PATEL, Shah Alam, Selangor (MY)

(21) Appl. No.: 17/265,470

(22) PCT Filed: Aug. 1, 2019
(86) PCT No.: PCT/MY2019/050041

§ 371 Date: Feb. 2, 2021

(30) Foreign Application Priority Data
Aug. 3, 2018 (MY) PI 2018702730

(51) Int. Cl. F25B 29/00; F24D 3/18; F24D 17/02; F24H 4/04

(52) U.S. Cl. CPC F25B 29/003; F24D 3/18; F25B 2400/01; F24H 4/04; F24D 2200/123; F24D 17/02

(57) ABSTRACT

A heating system for heat recovery from a liquid with an above-ambient temperature, which separates the heating process into a plurality of preheat stages. The heat pump includes an evaporator coupled to a heat generating apparatus via a first pump to transfer heat and preheat fluid flowing through a first heat exchanger to 31° C.-33° C. A sub-cooler pre-heats the incoming fluid as the second stage to 40° C.-45° C. using residual heat after the condensing step. A condenser coupled to a second heat exchanger heats the preheat fluid discharged from the first heat exchanger to 40° C.-45° C. The condenser is coupled to a storage tank to heat the preheat fluid discharged from the second heat exchanger to 58° C. to 85° C. Heat is transferred through the heat pump from the heat generating apparatus to maintain temperature of the fluid flowing through the second heat exchanger and fluid in the storage tank.

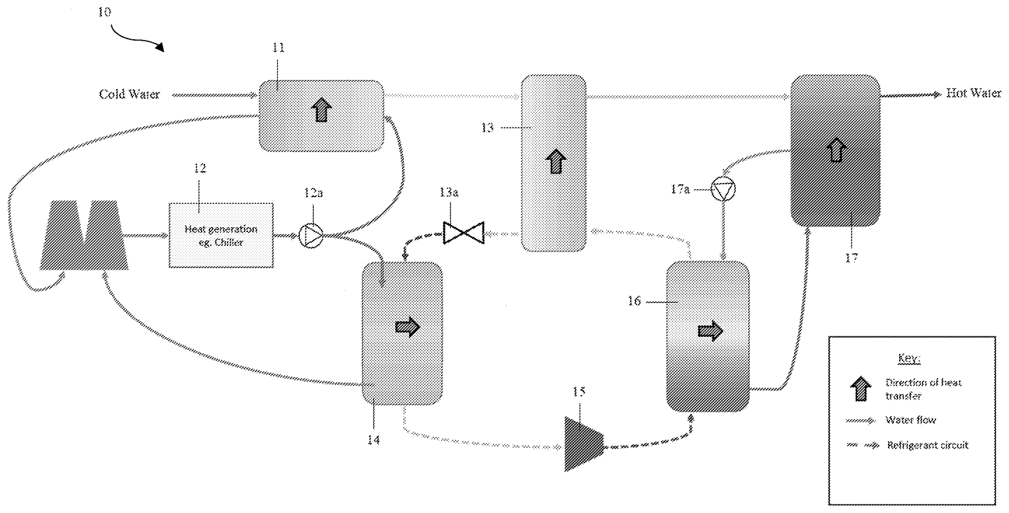

### TECHNICAL FIELD

The present invention relates generally to a heating system for buildings and industrial processes, and more particularly, to a heating system with integrated refrigerant system, or heat pump, for commercial buildings and industrial process heating applications.

### BACKGROUND OF INVENTION

An efficient heating supply is important for the hospitality, healthcare and industrial sectors. For such large consumers, heating is required consistently, on-demand, and is especially taxing towards conventional heating systems during peak hours.

Conventional heating solutions using electric heater to heat up fluid in storage tanks are highly inefficient and inconsistent in providing heated fluid to the consumers in such sectors. The task is further toughened as hot fluid usage in those industries varies during different hours. Therefore, improved heating solutions utilizing refrigerant systems, or heat pumps to recover waste heat are introduced.

U.S. Pat. No. 7,658,082 B2 introduces a heat transfer system with an integrated refrigerant system. The heat transfer system uses the refrigerant system to heat up cold water supplied from municipal water supply. The heat transfer system is designed for large structures, such as hotels, in which the demand for hot water changes according to the hour of the day. The prior art discloses a sub-cooler for pre-heating a municipal water supply. The prior art further discloses the process of water heating in multiple stages, where the municipal water source is first preheated from 10° C. to a temperature between 35° C. and 43° C. and the water output is at a temperature between 57° C. and 60° C. after the final heating stage. By having multiple heating stages, the heating system of this prior art may be able to provide hot water to meet demand in a reduced time. However, the design is not effective in yielding the highest possible temperature of the liquid of each stage of heating as it uses a single water loop through all stages. As different stages utilize different heating properties of the refrigerant, sensible heat in the form of the superheat at the desuperheater, latent heat at the condenser and sensible heat again in the sub-cooler, there are varying heating capacities at each stage. This limits the maximum temperature yield of the system

Hence, a more efficient solution was needed to tackle higher temperature heat sources available for recovery to generate higher temperature heating output from refrigeration systems without compromising efficiency and reliability.

### SUMMARY OF INVENTION

In order to overcome the problems mentioned above, the present invention proposes a heating system capable of providing constant hot fluid during heavy usage and a higher heat recovery efficiency from high temperature heat sources above ambient temperature. The heating system is designed to handle heating supply for use as hot fluid supply in commercial buildings and process heating in industrial applications. In this invention, the heating method has been separated into three stages so that the fluid is maintained at a particular temperature at different stages and to be able to recover the maximum amount of either sensible or latent available at each part of the refrigeration cycle and heat transfer process.

In this embodiment, the heating system of the present invention includes an integration with a heat pump. The heating system can be separated into three sections, namely first pre-heating, second pre-heating, and third condensing and storage sections.

In one embodiment of the present invention, the first pre-heating section consist of a plurality of apparatus for receiving water flow from public water supply and passively preheating the water to a temperature ranging from 31° C. to 33° C. or within 1 degree of the heat source temperature based on the heat source temperature being just above ambient temperature.

In another embodiment of the present invention, the second pre-heating section known as the sub-cooling stage, consisting an integrated heat pump. The heat pump having a refrigerant flowing and recirculated within to transfer heat from a heat source. After the condensing stage within the heat pump, the residual sensible heat is recovered to maximize the heating system's efficiency and heat recovery capacity. This heat is used to further heat up the preheated water flowing through the heat pump to a second temperature ranging from 40° C. to 45° C. depending on the water's flow rate.

In yet another embodiment of the present invention, the storage section comprises a water storage tank coupled to condensing stage of the heat pump for receiving the heat discharged from the heat pump through a controlled primary water circulation loop. The storage tank is coupled in such a way that it received heat discharged from the condensing stage from one part of the heat pump. The heat received from the heat pump will further heat up the water to a controlled and adjustable third temperature ranging from 58° C. to 85° C.

The benefit of having a three-stage design of the heat pump is to provide consistent heating under heavy demand while also maximizing the heat recovery efficiency from high temperature heat sources (higher than ambient temperature) and internally from each step of the refrigeration cycle. Each section of the heating system provides a partial amount of energy to gradually heat up the water based on its optimum heat supply potential depending on latent or sensible heat outputs based on the refrigeration cycle. Therefore, the present invention is capable of recovering higher temperature heat sources to generate higher temperature heating output without compromising the efficiency and reliability of the heating system.

### BRIEF DESCRIPTION OF DRAWINGS

The sole FIGURE is a schematic diagram showing the heating system in accordance with the present invention.

### DETAILED DESCRIPTION OF EMBODIMENTS

Described below are preferred embodiments of the present invention with reference to the accompanying drawings. Each of the following preferred embodiments describes an example in which the heating system improves over existing prior art.

The details of a heat pump, the expansion valve, evaporator, compressor, and condenser within the heat pump as described below will not be further explained, as it is a common knowledge for a person having ordinary skill in the art of thermodynamic engineering.

The configuration of the invention is not limited to the modules mentioned in the following description.

The working mechanism behind the heating system (10) of the present invention can be separated into three stages, namely first preheating stage, second preheating stage, and the condensing and storage stage.

In first preheating stage, the heating system comprises a first heat exchanger (11) for receiving fluid with ambient temperature from a public source. A heat source medium such as condenser fluid from a heat generating apparatus (12) such as a chiller is circulated to the first heat exchanger using a first pump (12a). The first heat exchanger facilitates the transfer of this heat to raise the temperature of the receiving fluid from the entering ambient temperature to a first temperature in the range of 31° C. to 33° C. in South East Asia. The heat source medium then returns to the heat generation source cooler to absorb further heat to repeat the process.

In the second preheating stage, the heating system is integrated with a heat pump with a refrigerant recirculated within the heat pump. The heat pump comprises a second heat exchanger (13) known as a sub-cooler for receiving preheated fluid from the first preheating stage. The sub-cooler receives high temperature liquid refrigerant from the condenser (16) where the residual sensible heat is removed by transferring it to preheated fluid from the first pre-heating stage, thereby heating it to a second temperature in the range of 40° C. to 45° C. The sub-cooler then also returns cooled liquid refrigerant to the evaporator (14) via an expansion valve (13a). By using the sub-cooler, an increase evaporator capacity is achieved enabling an increase amount of heat to be absorbed from the heat source medium, while also allowing higher condensing temperatures in the condenser (16) without risk of refrigerant starvation of the expansion valve due to insufficient condensation of refrigerant and sub-cooling.

The heat pump comprises an evaporator (14) for receiving the heat source medium such as condenser fluid from a heat generating apparatus (12) such as a chiller via the first pump (12a). It is understood in thermodynamic engineering that liquid refrigerant will enter the evaporator (14) and absorb heat through the evaporator (14) to fully vaporize into vapor. This vapor is then compressed by a compressor (15). The compressor (15) uses electrical energy to compress the vapor into a high temperature pressurized vapor. This vapor then enters a condenser (16) to be condensed back into a liquid form by transferring away the heat away through heat exchange to a waiting medium such as fluid circulated by a second pump (17a) between a storage tank (17).

In the storage and condensing stage, the heating system (10) comprises a storage tank (17) coupled to the second heat exchanger (13) for receiving the preheated fluid and the condenser (16) for transferring heat from the condensing refrigerant via a heat carrier liquid circulating between the condenser (16) and the storage tank (17). The storage tank (17) uses the condensing heat through the heat carrier liquid to further heat up the preheated fluid stored in the storage tank (17) to a third temperature, preferably in the range of 58° C. to 85° C. Upon releasing the excess heat in the storage tank (17), the heat carrier liquid will then return to the condenser (16) via a second pump (17a). The action of the heat carrier liquid flowing back and forth between the condenser (16) and the storage tank (17) is recirculated so that the heat carrier liquid is able to keep receiving heat from the condenser (16) and releasing heat to the storage tank (17).

The heating system (10) of the present invention uses recirculated technique to fully utilize the waste heat discharge from each stage to heat up the fluid to certain temperature in the three stages. The temperatures in the three stages are then maintained constantly as the excess heat are constantly flowing through and receiving by the first heat exchanger (11), the second heat exchanger (13) and the storage tank (17). The instability of hot fluid temperatures out of the storage tank (17) has been greatly reduced by comparing with the prior art described above by improving the thermal stratification within the storage tank by having preheated fluid enter the storage tank instead of fluid that is of ambient temperature. Also, the heating system (10) of the present invention has eliminated the frequent turning on and off of the electrical power, as the heat pump is running constantly and thus, the heating system (10) of the present invention also reduces electrical power consumption and improves the reliability through reduced motor and compressor cycling.

A summary then of what has been hereinbefore described by way of example of the present invention is a heating system (10) for heating up fluid in different stages and maintaining a constant temperature across these stages comprising a first heat exchanger (11) receiving heat from a heat generating apparatus (12) to preheat the fluid flowing through, a heat pump integrated within the heating system (10) having a second heat exchanger (13) for receiving the fluid from the first heat exchanger (11) and further heat up the fluid to a second temperature, and a storage tank (17) for receiving fluid from the second heat exchanger (13) and heat from the heat pump to further heat up the fluid to a third temperature. The heat received from the storage tank (17) is recirculated between the storage tank (17) and the heat pump in order to maintain the fluid temperature as stored in the storage tank (17).

In as much as the present invention is subject to many variations, modifications and changes in detail, it is intended that all matter contained in the foregoing description or shown in the accompanying drawings shall be interpreted as illustrative and not in a limiting sense.

1. A heating system for heating a fluid, comprising:
a first heat exchanger;
a first pump coupled to the first heat exchanger;
a heat generating apparatus coupled to the first pump;
a storage tank for receiving and storing a fluid;
wherein, the heat generating apparatus generates heat and transfer the heat to the first heat exchanger to preheat the fluid flowing into the first heat exchanger to a first temperature;
wherein the heating system is integrated with a heat pump having refrigerant circulating within the heat pump;
wherein, the heat pump receives heat generated from the heat generating apparatus to compress and transfer the heat to the preheated fluid to a second temperature when the preheated fluid from the first heat exchanger flows through the heat pump; and
wherein, the heat pump further transfers heat to the storage tank to further heat up the fluid stored in the storage tank to a third temperature.

2. The heating system in accordance with claim 1, wherein the heat pump comprises an evaporator coupled to the first pump for receiving a heat source medium from the heat generating apparatus to vaporize the refrigerant in liquid state received from an expansion valve.

3. The heating system in accordance with claim 2, wherein the heat pump comprises a compressor for receiving the vapor from the evaporator and compresses the vapor into a high pressure and temperature vapor using electrical power.

4. The heating system in accordance with claim 3, wherein the heat pump comprises a condenser for receiving the high pressure and temperature vapor from the compressor to condense the vapor into liquid and to discharge the heat released from the vapor.

5. The heating system in accordance with claim 1, wherein the condenser is coupled to the storage tank and released heat is transferred from the condenser to the storage tank to heat up the fluid stored therein to the third temperature.

6. The heating system in accordance with claim 1, wherein the heat pump comprises a second heat exchanger coupled to the first heat exchanger for receiving the preheated fluid discharged from the first heat exchanger.

7. The heating system in accordance with claim 6, wherein the second heat exchanger receives heat discharged from the condenser to further heat up the preheated fluid flowing through the second heat exchanger to the second temperature.

8. The heating system in accordance with claim 1, wherein the heat pump comprises a second pump coupled between the storage tank and the condenser for allowing hot fluid to circulate between the storage tank into the condenser to maintain the heat stored in the fluid stored in the storage tank.

9. The heating system in accordance with claim 1, wherein the storage tank is preferably a thermal storage tank.

10. The heating system in accordance with claim 1, wherein the heat generating apparatus is preferably a chiller.

11. The heating system in accordance with claim 1, wherein the first temperature is preferably in the range of 31° C. to 33° C.

12. The heating system in accordance with claim 1, wherein the second temperature is preferably in the range of 40° C. to 45° C.

13. The heating system in accordance with claim 1, wherein the third temperature is preferably in the range of 58° C. to 85° C.
